(19) United States
(12) Patent Application Publication
(10) Pub. No.: US 2014/0052030 A1
(43) Pub. Date: Feb. 20, 2014

(54) SYSTEM TO APPLY MECHANICAL AND PHYSIOLOGICAL THERAPEUTIC STRESS TO ANIMAL AND HUMAN TISSUE

(71) Applicant: University of Iowa Research Foundation, Iowa City, IA (US)

(72) Inventor: Richard K. Shields, Iowa City, IA (US)

(73) Assignee: University of Iowa Research Foundation, Iowa City, IA (US)

(21) Appl. No.: 13/967,686

(22) Filed: Aug. 15, 2013

Related U.S. Application Data
(60) Provisional application No. 61/683,978, filed on Aug. 16, 2012.

(51) Int. Cl. A61H 1/00

(52) U.S. Cl. CPC A61H 1/006
USPC 601/15; 601/46

(57) ABSTRACT

A method and apparatus for stimulating the tissue of an animal. The apparatus can comprise a vibration system configured to apply a vibration to the tissue. The apparatus can also comprise a compression system configured to compress the tissue. The system can deliver combinations of compressive or vibration stress to tissue either with or without background muscle contractions.

### PRIORITY

This application claims priority to U.S. Provisional Patent Application No. 61/683,978, filed Aug. 16, 2012 and is incorporated herein by reference in its entirety.

### BACKGROUND

This invention relates to compression and vibration systems. More particularly, this invention relates to systems that provide stress to living tissue for therapeutic purposes.

Vibration and compressive loads are mechanical stimuli that can be applied to biological tissue through external applications in the absence of or with internal forces through muscle contractions, such as, for example, muscle, bone, cartilage, adipose, or other tissue. Animal and human tissue can be injured due to various circumstances such as surgery, injury, disease, or paralysis; and healing naturally provided by the body of the animal can take place over extended periods of time. Modern medicine uses various methods like stem cell implants and other growth factors to enhance the growth and development of all living tissues that have deteriorated from disease, injury, surgery, paralysis, or other natural or unnatural causes. Modern medical research aspires to discover methods of speeding up the recovery process through the application of therapeutic stress that uses the body's natural healing properties to create a healthy cellular environment for cells, tissues, and organ repair and recovery.

### SUMMARY

Described herein is an apparatus for stimulating the tissue of animals or humans. The apparatus can include a vibration system configured to apply a vibration to the tissue. The apparatus can also include a compression system configured to compress the tissue. The apparatus can also include a method to electrically or volitionally activate muscle tissues while superimposing vibration and compression stresses either independently or in various combinations.

Methods of stimulating animal or human tissue are described. In exemplary methods, the method includes applying vibrations to the tissue. Additionally, the method can include compressing the tissue. In addition, the muscle tissue may be electrically stimulated or volitionally stimulated to add an additional therapeutic load to the muscle, bone, and cartilage tissues. The unique combinations with which human tissues are most responsive offers the capacity for faster healing after injury, surgery, or other disease processes that render muscle, bone, or other tissues to an unhealthy state. This may be of major importance as stem cell scaffolds and other cellular growth interventions emerge in modern medicine to enhance tissue repair.

### BRIEF DESCRIPTION OF THE FIGURES

These and other features of the preferred embodiments of the invention will become more apparent in the detailed description in which reference is made to the appended drawings wherein:

FIGS. 1A-B show a front view and side view of an example apparatus for stimulating tissue of human or animal.

FIG. 2 shows a schematic representation of an example vibration system.

FIG. 3 shows a schematic representation of an example compression system.

FIGS. 4A-D show an example apparatus and output of the vibration system, compression system, and the two systems together measured for 10 seconds or 1 cycle for an example apparatus. FIG. 4E shows the addition of muscle activation superimposed onto the vibration and compression loads.

FIGS. 5A-F show graphs of the acceleration of the vibration platform as measured by the second accelerometer and corresponding fast Fourier transforms.

FIG. 6 shows the transmissibility of the vibration of an example vibration system.

FIG. 7 shows a graph depicting ten compression cycles collected at example air pressures (20, 30, 40, 50, 60 psi) of the compression system.

FIG. 8 shows a flow chart diagram of an example method for stimulating a tissue of a human or animal.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof

As used throughout, the singular forms “a,” “an” and “the” include plural referents unless the context clearly dictates otherwise. Thus, for example, reference to “a delivery conduit” can include two or more such delivery conduits unless the context indicates otherwise.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

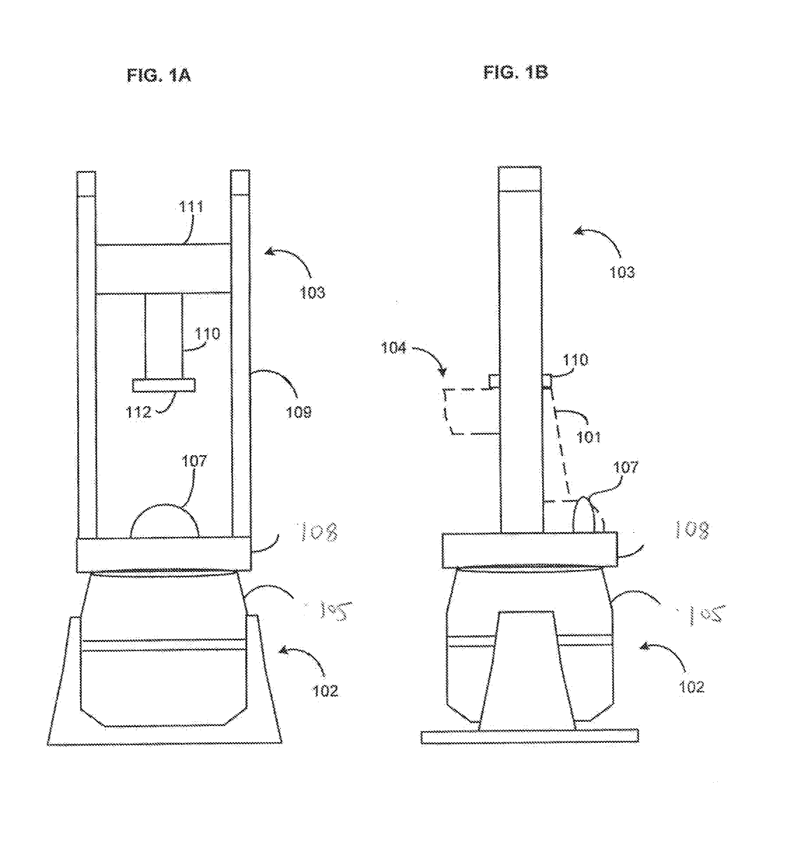

With reference to FIGS. 1-8, disclosed herein is a method and apparatus for applying a vibrational stress a mechanical loading stress, and a muscle electrical or volitional stimulation stress to human tissue. In one aspect of the invention, the method and apparatus are configured to deliver either high passive compressive stress and/or low vibration stress either independently or in various combinations with a muscle stress through electrical stimulation. Passive stress can comprise any stress applied external to the body. For example, passive compressive stress or passive vibrational stress can comprise stress applied to the tissue by contact with an outer layer of tissue such as skin. On the other hand, active stress can comprise stress created internally by muscle contraction. Muscle contraction can be activated by volitional stimulation when the animal or human actively contracts the muscle. Alternatively, active muscle stimulation can occur by application of an electrical current to a muscle causing it to contract. In addition, parameters of vibration including the gravitational force (g), frequency (f), and displacement can be adjusted. By designing the system to deliver a dynamic peak stress as well as a low amplitude vibration stress, the method and apparatus can be configured with the capability to offer unique combinations of mechanical stimuli that have not been previously implemented in combination.

The method and apparatus can be designed to have the ability to deliver the various doses of stress to a single leg (limb) segment, independent of transmitting the vibration to the brain (vestibular system) or opposite leg (limb). The unique combination of these doses of stress may be optimal for certain types of tissues, including tissues undergoing regenerative stimulation through tissue growth enhancers (stem cells). For example, the effects of vibration on bone density can be confounded by co-varying muscle contractions induced through systemically activating the vestibulospinal pathways. The ability to assess the influence of isolated mechanical stimuli to a peripheral segment can be examined in the absence of the systemic confounding factors associated with whole body (brain) vibration. Verifying that vibration stimulation does not transmit to the head and opposite limb allows us to test the specific combination of stresses that directly influence the tissue.

Additionally, the method and apparatus can be designed to ensure safety as therapeutic doses of stress can be capable of exceeding an individual's full body weight delivered to a single limb segment. The method and apparatus can be designed such that the hardware and software regulate doses of stress under precise feedback control. Shut down safety systems can be employed to prevent the delivery of loads that were not intended.

FIGS. 1A-B show representations of an example apparatus 100 for stimulating a tissue of a human or animal. FIG. 1A shows a front view of an example apparatus for stimulating a tissue of a human or animal. FIG. 1B shows a side view of an example apparatus for stimulating tissue 101 of a human or animal. For example, the tissue can be a human leg as shown in FIG. 1B. In one aspect, the apparatus can comprise a vibration system 102 configured to apply a vibration to the tissue 101. The vibration system can comprise a vibration device 105 (or shaker) configured to produce an oscillation in various directions. In one aspect, the apparatus can be programmed to oscillate according to the design needs of the particular apparatus.

The apparatus can comprise a compression system 103 configured to compress the tissue 101. The compression system 103 can comprise a plate 106 above the vibration device capable of transmitting mechanical oscillations communicated by the vibration device 105. In an aspect, a foot strap 107 can be attached to the top of the plate 108 allowing a human foot to be secured to the plate. The compression system 103 can further comprise a compression frame 109 configured to carry other elements of the compression system 103 such as a pneumatic compressing component 110 (e.g. a piston) configured to apply a compressive force to the tissue 101. In an aspect, the pneumatic compressing component 110 is attached to an adjustable housing 111 capable of adjusting the location of the pneumatic compressing component 110 in relation to the compression frame 109. Additionally, the pneumatic compressing component can include a pad 112 configured to interface with the tissue. An exemplary compression system 103 is described in further detail below.

In another aspect, the vibration system 102 and compression system 103 are configured to apply the vibrations to the tissue 101 and compress the tissue simultaneously. In an aspect, applying the vibrations to the tissue 101 and compressing the tissue can accelerate tissue growth. The vibration system 102 can be configured to transmit the vibrations only to a limited section 104 of tissues of the animal or human. The tissue 101 can be some or all of a human limb or animal limb, such as a leg as shown in FIG. 1B, but the apparatus can be configured for other limbs and animals.

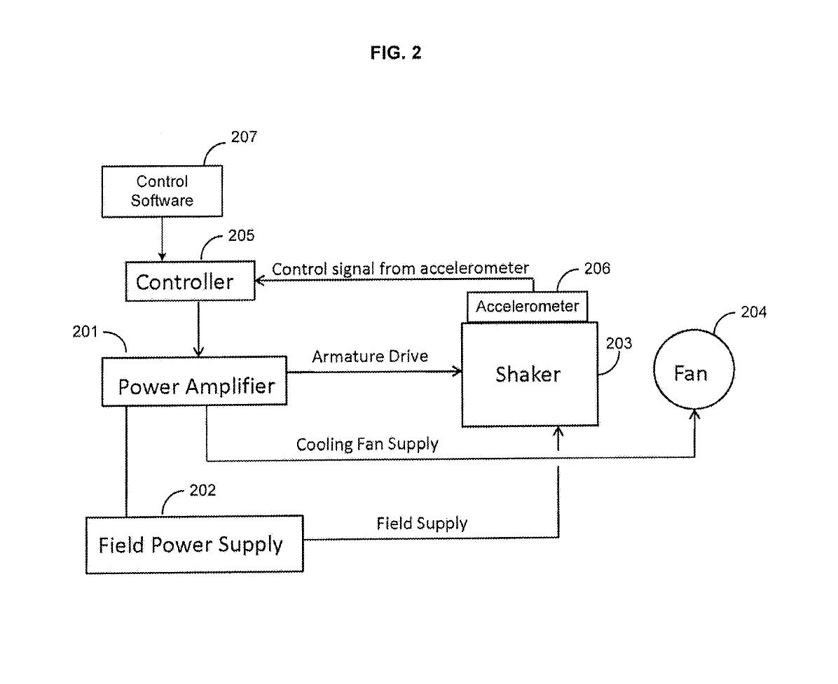

FIG. 2 shows a schematic representation of an example vibration system. In an aspect, the vibration system is a commercially available servo-controlled vibration system capable of producing vibration parameters according to design needs. In an aspect, the vibration system can be comprised of five components: a power amplifier 201, a field power supply 202, a shaker 203, a cooling fan 204, and a controller 205. For example, the vibration system can comprise a Ling Dynamic Systems (Royston, England) or Brüel & Kjwr(Denmark) PA1000L power amplifier 201, a FPS10L field power supply 202, a V722 shaker 203, a cooling fan 204, and a LaserUSB 6.30 controller 205. The power amplifier 201 and field power supply 202 can be connected in series and generate the required power for the vibration system. A magnetic field within the shaker 203 is generated from the field power supply 202 while the power amplifier 201 drives the shaker 203 and supplies power to the cooling fan 204. The cooling fan 204 can draw air through the shaker 203 and vent the air to the outside to dissipate heat generated.

In an aspect, the vibration system 102 can comprise an accelerometer 206. The accelerometer 206 can be attached to the shaker 203 and connected to the controller 205, and the controller 205 can be connected to the amplifier 201 creating a feedback loop. The power amplifier 201 can increase the magnitude of vibration until the shaker 203 reaches a specified level of vibration. The user can define the duration and magnitude of the vibration in terms of frequency in Hertz (Hz) and acceleration in gravitational force of earth (g=9.81 m/s2). The control software 207 can be configured to allow the user to program multiple loops thereby creating a series of on and off cycles of vibration. In an aspect, the controller 205 can also be equipped with an abort button which is designed to stop the vibration quickly. When providing a mechanical intervention to humans, such functionality can provide built in safety mechanisms in the event of an emergency.

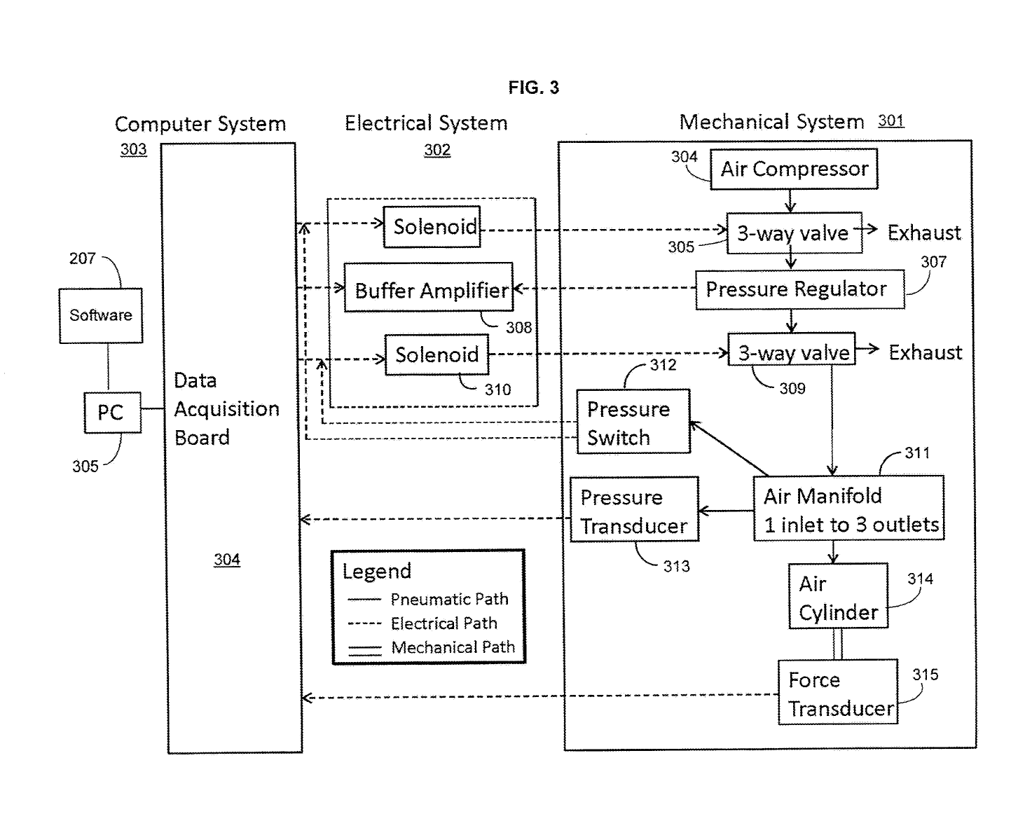

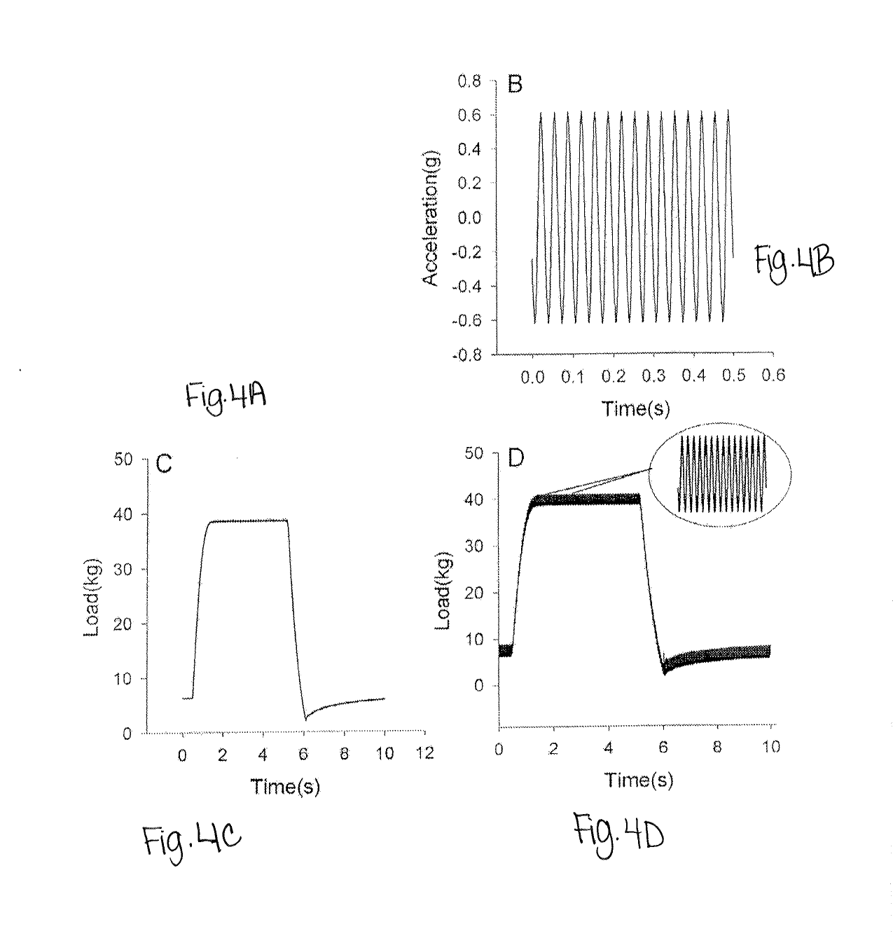

In addition to the vibration system, the apparatus 100 can comprise a compression system. In an aspect, the compression system 103 can be configured to safely deliver a load to a human or animal leg. FIG. 3 shows a schematic representation of an example compression system 102. The compression system can be broadly divided into three categories of components: a mechanical system 301, an electrical system 302, and a computer system 303. The mechanical system can comprise the hardware required to generate a pneumatic, compressive force and its interface with a subject. The electrical system 302 can provide power to all of the mechanical parts and link them to the computer system 303. In an aspect, the computer parts comprise a data acquisition (DAQ) board 304 and computer 305 complete with custom software 207 capable of controlling the entire compression system 103.

The mechanical aspect 301 of the compression system can comprise several components to generate the required force, many of which include additional electrical connections. The mechanical aspect 301 of an exemplary compression system 103 is illustrated through but not limited to the following example. The air flow can begin at the air compressor 304, which can be a Super Silent DR 500 Air Compressor (Silentaire Technology, Houston, Tex.). The air compressor 304 can regulate the air pressure entering the compressive system to any pressure level (lbs/in2(psi)). The air can then pass through a three-way solenoid valve 305 (for example, the Humphrey three-way solenoid valve manufactured by the Skarda Equipment Company, Inc., Omaha, Nebr.). When the solenoid 306 receives 12 Volts (V) from the electrical portion of the system, the valve 305 can close, and the compressed air can remain in the pneumatic system. However, in the absence of power the valve 305 can remain open and the air can vent to the atmosphere. If the valve 305 is closed then the air continues to the next component, an electrical pressure regulator 307, T500X Miniature E/P Transducer (ControlAir Inc., Amherst, N.H.). The pressure regulator 307 can convert a voltage from a buffer amplifier 308 to a corresponding pneumatic output.

Continuing the illustration, the air can then move through a second three-way valve 309 with a second solenoid 310 and continue to an air manifold 311. In an aspect, the air manifold 311 can divide the air between a pressure switch 312, 2PSW2SYT5 Pressure Switch (Solon Manufacturing Co., Chardon, Ohio), a pressure transducer 313, PT100R13LU2H1131 Pressure Transducer (Turck Inc., Minneapolis, Minn.), and an air cylinder 314, USR-32-1 Pneumatic Cylinder (Clippard Instrument Laboratory, Inc., Cincinnati, Ohio). The pressure switch 312 can be composed of two electrical switches and a diaphragm sensing element. If the pressure is greater than what is deemed a safe level of pressure (for example 60 psi), then the circuit can be tripped and the compression system 103 can shut down. The pressure switch 311 can be one of the safety mechanisms built into the system. The pressure transducer 313 can convert the pneumatic input to a voltage that is sent to the electrical portion of the system. The desired air pressure can continue into the chamber of the air cylinder 314 causing the piston to move downward. A force transducer 315, 1210ACK-300lb Load Cell (Interface, Scottsdale, Ariz.), and pad are attached to the piston which measures the applied load to the leg.

In an aspect, the compression system 103 can be designed to introduce a load to the proximal leg as a percent of body weight. A feedback loop can be incorporated into the software design to continuously monitor the force and pressure through the transducers 313 and 315 and adjust accordingly. Software can comprise, for example, LabVIEW 8.6 (National Instruments, Austin, Tex.). A graphical user interface (GUI) can be created to allow the user to easily input the desired mechanical conditions. A user can define the amount of time the compression is on and off in seconds, the number of cycles, and the magnitude of the force. Additionally, data can be collected and real-time plots of force and pressure can be generated and displayed.

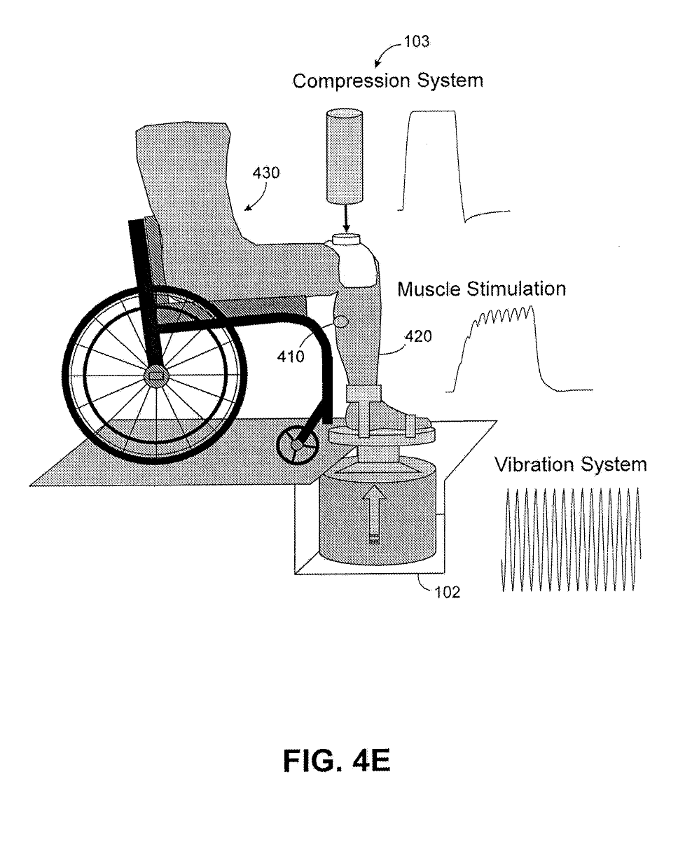

FIG. 4A shows a participant seated in an adjustable lift with the lower limb secured to the human interface of an example apparatus. A custom designed compression frame can be fixed to the vibration shaker. The cabinet rack can house the compression hardware, DAQ board, computer, vibration controller, field power supply, and power amplifier. In an aspect, the compression system can comprise a compression frame, which can be a custom compression frame fabricated and attached to the shaker to apply the load. The frame can be made of an aluminum base plate and foot plate connected with, for example, 80/20 ‘T-slot’ frames, and can also comprise uprights and a cross bar, which can in one embodiment be made with the 80/20 material. In an aspect, the compression frame can comprise an adjustable housing made of a sturdy material such as aluminum. The housing can contain, for example, an air cylinder and slides within the 80/20 uprights thereby making it adjustable. In addition, a wheelchair, can be fitted to a lift that allows for optimal positioning relative to the apparatus for patients who are confined to a wheelchair.

FIGS. 4B-D show the output of the vibration system 102, compression system 103, and the two systems together measured for 10 seconds or 1 cycle for an example apparatus 100. FIG. 4B shows the acceleration of the vibration platform. FIG. 4C shows the force of the compression system. FIG. 4D shows the force measured when both systems are working simultaneously.

FIG. 4E shows the present invention in one embodiment, whereby one or more of a vibration system 102, a compression system 103 and a muscle stimulator 410 may be applied to, for example, a leg 420 of a participant 430.

### System Performance Verification

### Accuracy of Delivering Vibration Parameters and Peak Vertical Load to Human Limb Segment

In an aspect, the apparatus is configured to introduce a vibratory and compressive load to a single segment. To verify that the compression system is delivering the desired acceleration, an accelerometer, Model 3233A High-Sensitivity triaxial accelerometer (Dytran Instruments, Inc., Chatsworth, Calif.), can be attached to the vibration platform. Laser vibration software can be programmed for 0.6 g at 30 Hz for 1 minute while acceleration can be collected in all the cardinal directions. The x and y axes can be configured as parallel to the platform and the z axis can be configured as a perpendicular measure of the acceleration in the vertical direction. A custom MATLAB (Math Works, Natick, Mass.) or other software program can be written to determine the peak of the acceleration and its frequency content, and the peak can be defined as the maximum value of the acceleration signal. To determine the frequency of the signal, a fast Fourier transform (FFT) can be performed. Within the one minute data collection, 32.7680 seconds or 2̂17 data points can be extracted so that the length of data is a power of 2, the recommended length for a FFT.

After assessing the vibration signal, the accuracy of the compressive load can be determined. The custom compression software can be configured to control the air pressure to apply the desired load to the lower leg. Calibration of the system can be performed to identify the pneumatic pressure and its corresponding load. To verify the load resulting from this input pressure, for example, five pressures (20, 30, 40, 50, 60 psi) can be programmed into the system and the force can be measured. In an aspect, ten cycles can be collected at each pressure. The accuracy of the compression system can be measured by determining the linearity, repeatability, and percent error. Linearity is defined as the maximum deviation between the predicted and the measured load, repeatability is the maximum difference between measures under the same testing conditions while percent error is the difference between the measured and the predicted value. In an aspect, the purpose of validating the compression system can be to ensure that an unsafe load will not be delivered. Therefore, the system can be configured to meet minimum requirements in order to be deemed suitable for experimental use in humans. An accurate compression system can be configured to fulfill the predefined operating specifications (for example ±5% linearity, ±1% repeatability, ±1% error). Prior to this air pressure validation, the load cell can be calibrated using known weights to ensure the accuracy of the measured load.

One example of the use of the compression system can be to provide a musculoskeletal intervention to completely paralyzed individuals. For example, these individuals may undergo compression sessions on different days to determine the inter-session reliability. In one embodiment, ninety compressive load cycles of 50% body weight can be delivered to the leg, where these five second loading cycles can be separated by five second rest periods, and the peak load can be measured after cycles 1, 30, 60, and 90 for each session. The difference between sessions and the intraclass correlation (ICC) at each time point can be calculated (IBM SPSS Statistics Version 19), where a strong association (e.g., ICC >0.8) can indicate that the system can deliver similar amounts of mechanical load for each session and that the load can be reliably delivered. Throughout the intervention, each session can be configured to remain fixed to avoid introducing confounding variables.

### Transmissibility of Limb Segment Vibration to Head and Opposite Limb

Since a primary goal of this apparatus, for example, can be to deliver vibration to only a single limb segment, the transmissibility of the mechanical oscillations can also be determined. An accelerometer can be attached to the tibial tuberosity, femur, and head during the vibration protocol of both the vibrated and contralateral limb. In this case, transmissibility is defined as the ratio of root mean square (RMS) of acceleration of the anatomical site to the RMS of the acceleration at the mechanical apparatus.

$$Transmissability = \frac{{RMS}_{acceleration\_body}}{{RMS}_{acceleration\_platform}}$$

Safety testing verifying system shut down with unexpected stress

Since the apparatus can be designed to interface with a human limb, the apparatus can be configured for human safety. Although the vibration parameters (for example, 0.6 g, 30 Hz) for a particular intervention can be safe for humans, the example vibration system can be capable of generating vibration signals with an acceleration of 66.3 g and frequency of 400 Hz. Several safety mechanisms can be implemented to limit the signal and remove the risk of bodily harm or injury. For example, the shaker parameters can be altered so that the maximum acceleration is 6 g, and the vibration system can be configured with several other built-in safety features. The commercial shaker itself can provide over travel protection that limits the peak-to-peak excursion to, for example, 11 mm. If the shaker exceeds 11 mm then the system can be configured to cease vibration. Finally, the vibration controller can be equipped with an abort button that will immediately shut down the system.

An example vibration system can be a commercially used vibration system that has been rigorously tested to ensure safety; however, the compression system can be custom designed, and thus, thorough testing can be employed before using the vibration system in human experiments. In an aspect, the compressive system can be outfitted with an emergency stop switch that removes the load by venting the air to the environment. In addition to a mechanical stop, the software can also be programmed to have other safety elements. Before starting the compression system the user can input the cycle time, air pressure, and maximum load. The maximum load is the safety parameter which can be set to ensure that an excessive load for human tibia cannot be applied.

To assess the sensitivity of the compression safety, an example air pressure of 38.1 psi or 100 lbs can be programmed into the system while varying the maximum load. In one example test, seven maximum load settings, 95 lbs, 98 lbs, 99 lbs, 100 lbs, 101 lbs, 102 lbs, and 105 lbs, were tested. The force was recorded using the custom LabVIEW software written to control the compression system. The effectiveness of the maximum load safety setting was determined by examining the force signal and measuring the peak force delivered.

### Results

### Accuracy of Delivering Vibration Parameters and Peak Vertical Load to Human Limb Segment

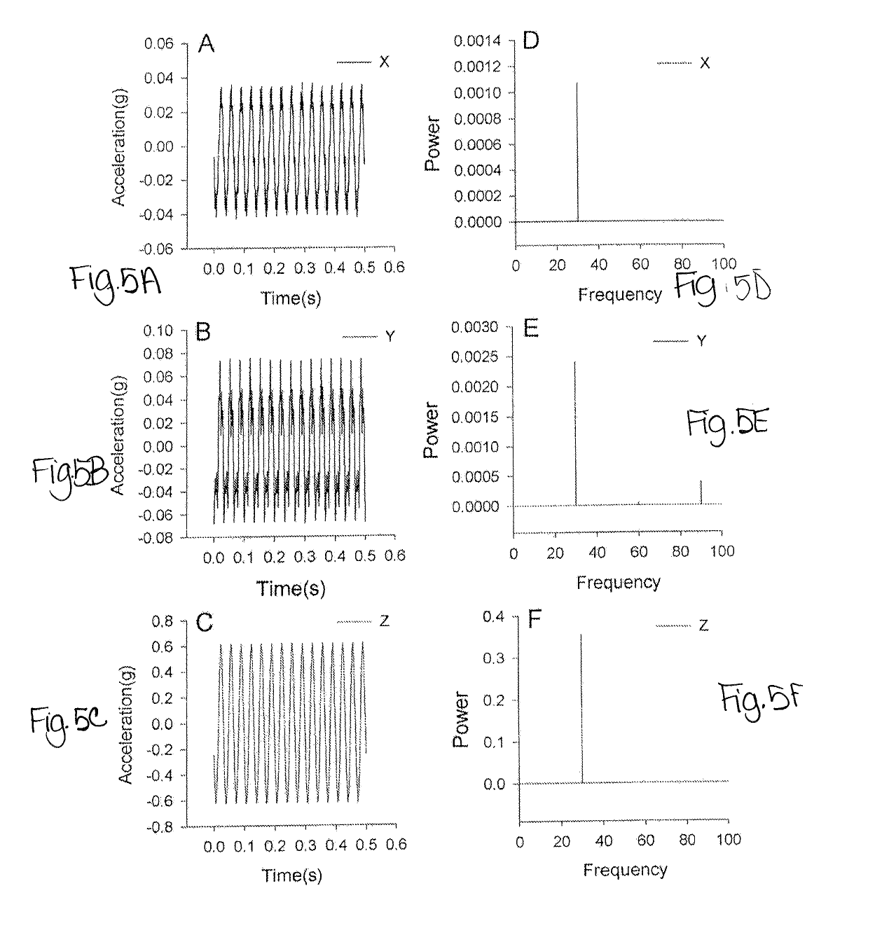

All of the components for the vibration system can be purchased through Bruek & Kjaer North America Inc., and such components can be extensively tested to ensure high accuracy. Additionally, a second accelerometer can be used to verify the magnitude and the frequency content of the vibration signal. FIGS. 5A-C show graphs of the acceleration of the vibration platform as measured by the second accelerometer. Magnitude of acceleration in the x, y, and z directions are shown. The graphs indicate that virtually all of the vibration can be configured to occur in the vertical or z direction with minimal acceleration in the axes parallel to the platform. FIGS. 5D-E show graphs of a fast Fourier transform of the vibration signal corresponding to FIGS. 5A-C. These graphs demonstrate that the frequency content of an exemplary configuration of the vibration system is frequency of 30 Hz. It also demonstrated that the z-direction contained most of the frequency content.

To test the vibration the acceleration and frequency can be set to, for example, 0.6 g and 30 Hz, respectively. According to these example settings, the peak in the x, y, and z direction can be measured at 0.0406 g, 0.0732 g, and 0.6289 g, respectively as shown in FIGS. 5A-C. Therefore, there was minimal acceleration in the planes parallel to the vibration platform while the majority of the signal occurred in the vertical direction. The graphs confirm that the acceleration for the example vibration system is in the correct direction and can provide single segment vibration at 0.6 g. The fast Fourier transform reveals the frequency of the signal was at 30 Hz, the frequency set by the user. Also, the highest power of the frequency occurred in the vertical z-direction at approximately 0.35 while the power remained low in the x and y directions. Although some of the signal occurred at 60 Hz and 90 Hz in the y direction they are harmonics of the 30 Hz vibration.

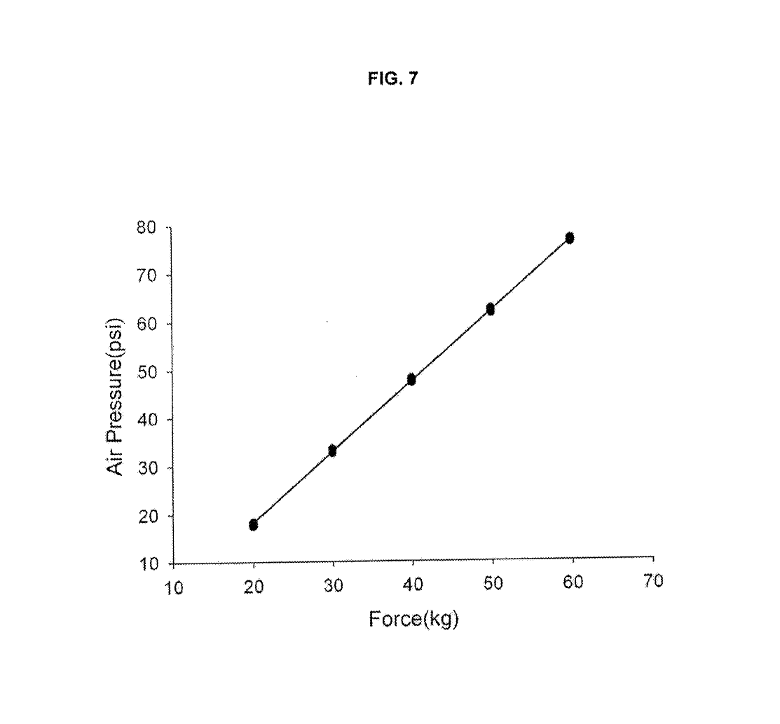

Following the validation of the vibration, the accuracy of the compression system can be tested by specifying various air pressures and measuring the corresponding forces. FIG. 7 shows a graph depicting ten compression cycles collected at example air pressures (20, 30, 40, 50, 60 psi) of the compression system. FIG. 7 demonstrates that the relationship between pneumatic pressure and compressive load can be linear with a Pearson correlation coefficient (r²) equal to 1.0. Linearity, repeatability, and error can be calculated at each air pressure to determine the accuracy of the compression system, as shown for an example compression system in Table 1 below. The data for Table 1 shows an example of how the varying air pressure relates to the compressive load for 10 cycles at each air pressure.

TABLE 1

| Pressure (psi) | Linearity (%) | Repeatability (% FS) | Error (% FS) |
|---|---|---|---|
| 20 | 3.79 | 0.54 | 0.51 |
| 30 | 1.75 | 0.57 | 0.42 |
| 40 | 1.26 | 0.61 | 0.44 |
| 50 | 0.83 | 0.69 | 0.38 |
| 60 | 0.58 | 0.54 | 0.32 |

Linearity is a measure of how closely the force output matches the predicted force. A low value indicates that the predicted force is close to the actual measured force. The linearity of the system provides a method to quantify the accuracy of the system. Repeatability is the difference between the maximum and minimum force at each air pressure and expressed as a percent full scale (FS). The load cell can have any maximum capacity based on the load cell selected. Repeatability and percent error for the system can be calculated.

Once the accuracy of the compression system itself is verified, it can be used on a cohort of individuals with or without paralysis to determine its precision with a human interface. The inter-session reliability of the compressive load can be determined on different testing days but under the same loading conditions. The compression system can deliver a load in a cyclic fashion of 5 seconds of compression followed by 5 seconds of rest. Table 2 shows an example of the percent change and intraclass correlation at these 4 time points.

TABLE 2

| | Change (%) ± | |
|---|---|---|
| Cycle | SD | ICC |
| 1 | 5.07 ± 2.74 | 0.917 |
| 30 | 3.43 ± 1.43 | 0.965 |
| 60 | 6.53 ± 3.98 | 0.899 |
| 90 | 3.06 ± 2.75 | 0.965 |

The example compression system can have excellent between-day reliability and can provide reproducible single segment loading in humans.

### Transmissibility of Limb Segment Vibration to Head and Opposite Limb

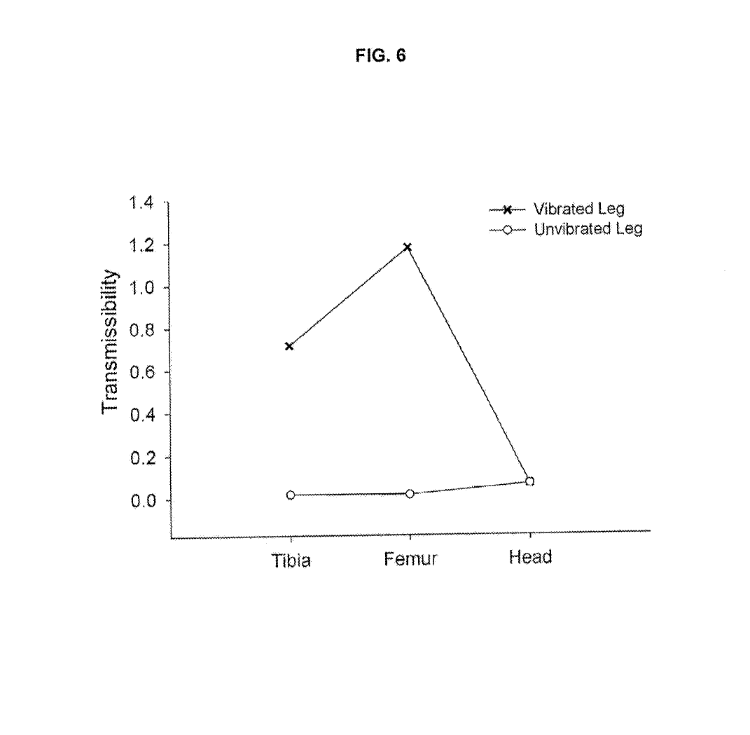

FIG. 6 shows an example of the transmissibility of the vibration system. The transmissibility of the vibration signal can be calculated as a ratio of the anatomical landmark root mean square (RMS) to the RMS of the platform. An accelerometer can be placed on the tibia and femur of the vibrated and unvibrated leg as well as the head. In an aspect, the vibration system can be configured to limit the transmissibility of the vibration to a single segment. In order to determine the transmissibility of the vibration signal an accelerometer can be attached to various anatomical landmarks including the tibia, femur, and head. A transmissibility of 1.0 can indicate that the acceleration on anatomical site is equivalent to the acceleration of the vibration plate. The transmissibility of acceleration measured at the tibia and femur of the vibrated limb can be measured for the example vibration system. However, the transmissibility of vibration at the head and the contralateral tibia and femur can be minimal. Therefore, the example vibration system can successfully deliver the correct acceleration in magnitude and frequency to the human leg or target tissue while limiting its transmissibility to other tissues.

### Safety Testing Verifying System Shut Down with Unexpected Stress

In an aspect, the apparatus 100 is configured to safely introduce the mechanical intervention of vibration and compression to a human leg. Accordingly, both the vibration system and the compression system can be equipped with functioning safety switches. Tests on an example vibration system showed that the vibration system shutdown when the acceleration was greater than 6 g, the shaker exceeded 11 mm of displacement, or the user pushed the abort button on the controller. Activating the emergency stop switch in the compression system immediately exhausted the air and removed the load. The compression software can be more extensively tested to determine if the embedded safety mechanisms are working properly.

Within the compression software, a maximum load can be set to prevent an unexpected load to the tibia. For example, a load of 100 lbs (38.1 psi) can be input into the system with various maximum load settings to determine the sensitivity of the safety mechanism. Every time the system exceeds the preset maximum load, the air can be exhausted by the 3-way valve to below the preset. To check the safety mechanism, the maximum load for an example compression system can be set to 95 lbs, 98 lbs, and 99 lbs with a target load of 100 lbs. In such case, testing could indicate that these maximums were exceeded by 2.55 lbs, 2.11 lbs, and 1.65 lbs, respectively, in the example compression system. Since the compression software uses the air pressure to deliver the load, the compression system can be configured not to exceed 100 lbs because it was programmed to 38 psi or 100 lbs. To ensure that the compression system has been thoroughly tested and is working properly, the maximum load can be set to 100 lbs, 101 lbs, 102 lbs, and 105 lbs. In testing of the example compression system, none of these maximum presets engaged the safety mechanism because the maximum load delivered to the leg did not exceed 100 lbs.

### DISCUSSION

In an aspect, three design criteria can be used to determine the performance of the apparatus (1) the accuracy and repeatability of the device, (2) the transmissibility to other tissues, and (3) the safety of the device.

Accurately and reliably introducing mechanical loads has many potential applications. Bone can adapt to high mechanical stress resulting in osteogenesis. Muscle contractions and gravitational load can provide bone with an osteogenic stimulation and in their absence, (spinal cord injury)SCI, bedrest, or spaceflight bone deteriorates. One application of the apparatus would be to use vibration and compression on bone density both with and without electrical stimulation.

The mechanical signals generated by the system have potential to affect bone, adipose, skeletal muscle, and cartilage. Low level vibration can improve fracture healing in an osteoporotic animal model. In addition to osteogenesis, mechanical oscillations can inhibit expression of skeletal muscle atrophy genes and stimulates hypertrophy. Vibration training can reduce fat volume and suppression of adipogenesis while cyclic compressive loading can enhance the integrity of cartilaginous tissue. The apparatus can be configured to expose the human leg to vibration, compression, muscle activation or a combination of all three or two of the stresses.

In an aspect, the system can be verified as to its ability to shut down following an unexpected stress. In some aspects, the ideal population for this mechanical intervention can have low bone density and be prone to fracture. Accordingly, the apparatus can be configured to prevent a large unexpected load from being delivered. Individuals with spinal cord injury can be ideal candidates to benefit from this technology; however, they can be twice as likely as the general population to sustain a lower extremity fracture. Therefore, the compression system can be configured to not exceed the maximum load set by the user. Individuals with any level cellular injury or repair may benefit from introducing an optimal stress either singularly or in combination thereof including joint cartilage, ligament, bone, muscle or other tissue that one would like to heal or regenerate.

### CONCLUSIONS

The method and apparatus of the present invention can (1) deliver accurate and repeatable vibration and compression, (2) limit transmissibility to other tissues, and (3) load the segment safely through external loads from the system and internal loads through skeletal muscle contraction either volitionally or electrically induced. In one embodiment, the vibration and compression system of the present invention can successfully provide lower leg vibration that can vary with respect to magnitude and frequency and compressive loads that can be modulated based on percent body weight. In addition, this can be coupled with volitionally activated muscle contractions or non-volitionally activated muscle contractions through electrical stimulation. The present invention is well-suited to be used on humans and other animals, and can limit the mechanical intervention to an isolated body segment. These loads can be delivered safely without risk of excessive stress. With its wide-ranging and diverse applications, the present invention can provide therapeutic environments to enhance healing and answer pertinent research questions and advance knowledge of vibration and compression on human tissue.

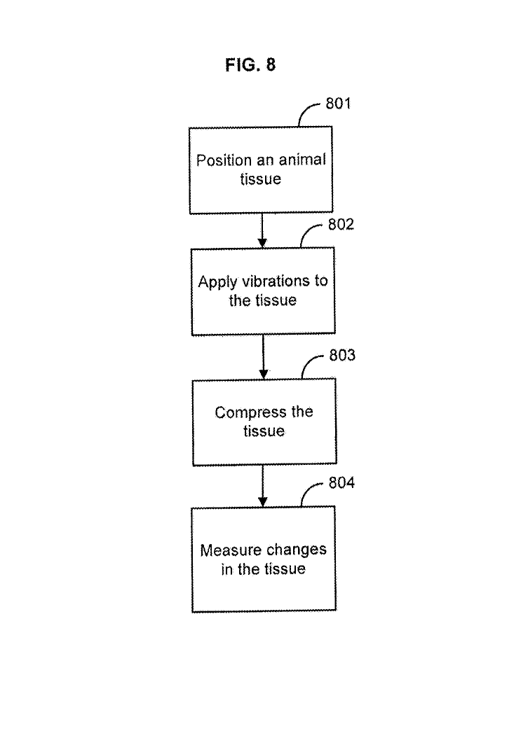

FIG. 8 shows a flow chart diagram of an example method for stimulating a tissue of an animal using the apparatus described above. The method can comprise a positioning step 801 of positioning animal tissue with respect to the apparatus, a vibration step 802 of applying vibrations to the tissue, and a compression step 803 of compressing the tissue. In an aspect, the vibration step 802 and the compression step 803 may be performed simultaneously. The vibration step 802 and the compression step 803 can be performed such that applying the vibrations to the tissue and compressing the tissue accelerate tissue growth. In an aspect, the method can be performed such that vibrations are transmitted only to a limited section of tissues of the animal/human. In a further aspect, the method can comprise a measuring step 804 of measuring changes in the tissue.

### LIST OF ABBREVIATIONS USED

fMRI—functional magnetic resonance imaging

NMES—neuromuscular electrical stimulation

SCI—spinal cord injury

TMS—transcranical magnetic stimulation

DAQ—data acquisition

PC—personal computer

FFT—fast fourier transform

RMS—root means square

EMG electromyography

BW—body weight

FS—full scale

ICC—intraclass correlation

r²—Pearson correlation coefficient

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. An apparatus for stimulating a tissue of an animal, the apparatus comprising:
a vibration device configured to apply a vibration to the tissue; and
a compression device configured to compress the tissue.

2. The apparatus of claim 1, wherein the vibration device and compression device are configured to apply the vibrations to the tissue and compress the tissue simultaneously.

3. The apparatus of claim 1, wherein the vibration device and compression device are configured to apply the vibrations to the tissue and compress the tissue at different times.

4. The apparatus of claim 1, further comprising a stimulator, for providing electrical stimulation to the tissue.

5. The apparatus of claim 4, wherein the stimulator provides electrical stimulation while either or both the vibration device and the compression device are applying vibration and compression to the tissue.

6. The apparatus of claim 1, wherein applying the vibrations to the tissue and compressing the tissue accelerates tissue growth.

7. The apparatus of claim 1, wherein the vibration system is configured to apply the vibrations only to a limited section of tissue of the animal.

8. The apparatus of claim 1, further comprising a device for measuring changes in the tissue in response to the applied vibration and compression.

9. The apparatus of claim 1, wherein the animal is a human.

10. The apparatus of claim 1, further comprising a controller for controlling the vibration device and the compression device.

11. The apparatus of claim 10, wherein the controller controls the vibration device and the compression device according to a selected protocol.

12. A method for stimulating a tissue of an animal, the method comprising:
applying vibrations to the tissue; and
compressing the tissue;

13. The method of claim 12, wherein the vibration and compressing steps are performed on the tissue simultaneously.

14. The method of claim 12, wherein the vibration and compressing steps are performed at different times.

15. The method of claim 12, further comprising the step of providing electrical stimulation to the tissue.

16. The method of claim 15, wherein the electrical stimulation is provided to the tissue while either or both the vibrations or the compression are applied to the tissue.

17. The method of claim 12, wherein applying the vibrations to the tissue and compressing the tissue accelerates tissue growth.

18. The method of claim 12, wherein the vibration is applied only to a limited section of tissue of the animal.

19. The method of claim 12, further comprising the step of measuring changes in the tissue in response to the applied vibration and compression.

20. The method of claim 12, wherein the animal is a human.

21. The method of claim 12, further comprising the step of controlling the vibration device and the compression device.

22. The method of claim 21, wherein the controlling is performed according to a selected protocol.
